(19) United States
(12) Patent Application Publication
(10) Pub. No.: US 2015/0306587 A1
(43) Pub. Date: Oct. 29, 2015

(54) Superficially Porous Hybrid Monoliths with Ordered Pores and Methods of Making and using same

(71) Applicant: AGILENT TECHNOLOGIES, INC., Santa Clara, CA (US)

(72) Inventors: Ta-Chen Wei, Newark, DE (US); William E. Barber, Landenberg, PA (US); Kunqiang Jiang, College Park, MD (US)

(21) Appl. No.: 14/442,988

(22) PCT Filed: Sep. 27, 2013
(86) PCT No.: PCT/US2013/062478

§ 371 Date: May 14, 2015

Related U.S. Application Data
(60) Provisional application No. 61/728,824, filed on Nov. 21, 2012.

(51) Int. Cl. B01J 31/02; B01J 20/28; B01J 37/08; B01J 20/30; B01J 35/10; B01J 20/10; B01J 20/22

(52) U.S. Cl. CPC B01J 31/0201; B01J 20/103; B01J 20/28085; B01J 20/28083; B01J 20/28088; B01J 20/28059; B01J 20/28061; B01J 20/22; B01J 20/3078; B01J 35/1061; B01J 35/108; B01J 35/1009; B01J 35/1014; B01J 35/1019; B01J 37/08

(57) ABSTRACT

The invention provides superficially porous metal oxide or hybrid metal oxide monoliths with ordered pore structures. The superficially porous hybrid silica monoliths of the invention provide several major advantages over existing silica monoliths. When used in chromatography, the superficially porous hybrid silica monoliths of the invention deliver fast separation at very low back pressure and possess superb pH stability and much improved mechanical strength.

### PRIORITY CLAIMS AND RELATED PATENT APPLICATIONS

This application claims the benefit of priority from U.S. Provisional Application Ser. No. 61/728,824, filed on Nov. 21, 2012, the entire content of which is incorporated herein by reference in its entirety.

### FIELD OF THE INVENTION

The invention generally relates to superficially porous monoliths. More particularly, the invention relates to superficially porous hybrid metal oxide monoliths with ordered pores and to methods for making and using the same.

### BACKGROUND OF THE INVENTION

Silica monoliths with hierarchical porous structure were first introduced in 1996. (Minakuchi, et al. 1996 Anal. Chem. 68, 3498; U.S. Pat. No. 5,624,875 to Nakanishi, et al.) Since then, silica monoliths have attracted great interest due to their bimodal porous structures and potential applications in catalysis, adsorption, sensing and separations. When used as a separation media for high performance liquid chromatography (HPLC), for instance, the high external porosity from the large co-continuous through-pores allows operation at fast flow rates (high linear flow velocities) with low back pressure. In addition, silica monoliths can be formed as a single rod and thus avoid issues associated with particle packing and with the use of fits to retain the separation media inside the chromatography column.

Much effort has been spent over the years on improving the efficiency by reducing the domain size, which is the sum of the size of silica skeleton and through pores. However, major challenges remain in further increasing separation efficiency. One such challenge is the inhomogeneous distribution of the macroporous skeleton. Another is the undesirable diffusion within the mesopores. Moreover, existing silica monoliths typically have insufficient mechanical strength as well as poor pH stability due to silica composition/chemistry of the monolith and high porosity and thin skeleton.

Thus, there remains an unmet need for metal oxide monoliths with improved physical and chemical characteristics, for example, those that deliver fast separation at very low back pressure and possess excellent pH stability and mechanical strength.

### SUMMARY OF THE INVENTION

The invention is based in part on the unexpected discovery of superficially porous monoliths with ordered pore structures. When used in chromatography, for example, the superficially porous monoliths of the invention deliver fast separation at very low back pressure and possess superb pH stability and much improved mechanical strength.

In one aspect, the invention generally relates to a porous monolith, which includes: (1) an organically modified porous skeleton comprising continuous macropores; and (2) a substantially porous outer shell comprising substantially ordered mesopores. Each of the skeleton and the outer shell is independently metal oxide or hybrid metal oxide. The metal oxide is selected from silica, alumina, titania and zirconia.

In another aspect, the invention generally relates to a method for preparing substantially metal oxide or hybrid metal oxide monoliths. The method includes: providing macroporous monoliths with solid skeleton; and heating the macroporous monoliths in a basic aqueous environment in the presence of one or mixed surfactants at a pH and for a time sufficient to create porous outer shells thereon having substantially ordered mesopores.

In yet another aspect, the invention generally relates to a superficially porous monolith, The monolith includes: (1) a porous skeleton comprising continuous macropores with a median pore size ranging from about 0.5 μm to 10 μm; (2) a substantially porous outer shell comprising mesopores with a median pore size ranges from about 1 nm to about 100 nm with a pore size distribution (one standard deviation) of no more than 50% of the median pore size; wherein the skeleton is a hybrid silica skeleton comprises silica and bridged silsesquioxane. The superficially porous monoliths have a median surface area in the range from about 50 m²/g to about 500 m²/g. In certain preferred embodiments, the mesopores in the substantially porous outer shells are substantially ordered.

### BRIEF DESCRIPTION OF THE DRAWINGS

FIG. 1. SEM (scanning electron microscopy) images of Example 1A, 2A and 2B.

FIG. 2. SEM of Example 3.

FIG. 3. TEM images of an Example 3.

FIG. 4. SEM images of an Example 4.

FIG. 5. TEM (transmission electron microscopy) images of an Example 4.

FIG. 6. Exemplary N₂ sorption data from Example 3 (Surface Area: 171 m²/g; Pore Volume: 0.26 cm³/g; Pore Size: 60 Å).

FIG. 7. Exemplary N₂ sorption data from Example 4 (Surface Area: 230 m²/g; Pore Volume: 0.36 cm³/g; Pore Size: 63 Å).

FIG. 8. Exemplary XRD (x-ray diffraction) data from Example 4.

### DEFINITIONS

Definitions of chemical terms and functional groups are described in more detail below. General principles of organic chemistry, as well as specific functional moieties and reactivity, are described in “Organic Chemistry”, Thomas Sorrell, University Science Books, Sausalito: 1999.

It will be appreciated that the compounds, as described herein, may be substituted with any number of substituents or functional moieties.

As used herein, “Cₓ-C_{y}” refers in general to groups that have from x to y (inclusive) carbon atoms. Therefore, for example, C₁-C₆ refers to groups that have 1, 2, 3, 4, 5, or 6 carbon atoms, which encompass C₁-C₂, C₁-C₃, C₁-C₄, C₁-C₅, C₂-C₃, C₂-C₄, C₂-C₅, C₂-C₆, and all like combinations. “C₁-C₂₀” and the likes similarly encompass the various combinations between 1 and 20 (inclusive) carbon atoms, such as C₁-C₆, C₁-C₁₂ and C₃-C₁₂.

As used herein, the term “alkyl”, refers to a hydrocarbyl group, which is a saturated hydrocarbon radical having the number of carbon atoms designated and includes straight, branched chain, cyclic and polycyclic groups. The term “hydrocarbyl” refers to any moiety comprising only hydrogen and carbon atoms. Hydrocarbyl groups include saturated (e.g., alkyl groups), unsaturated groups (e.g., alkenes and alkynes), aromatic groups (e.g., phenyl and naphthyl) and mixtures thereof.

As used herein, the term “Cₓ-C_{y} alkyl” refers to a saturated linear or branched free radical consisting essentially of x to y carbon atoms, wherein x is an integer from 1 to about 10 and y is an integer from about 2 to about 20. Exemplary Cₓ-C_{y} alkyl groups include “C₁-C₂₀ alkyl,” which refers to a saturated linear or branched free radical consisting essentially of 1 to 20 carbon atoms and a corresponding number of hydrogen atoms. Exemplary C₁-C₂₀ alkyl groups include methyl, ethyl, n-propyl, isopropyl, n-butyl, isobutyl, dodecanyl, etc.

As used herein, the term “ordered pores” refers to a matrix of pores arranged in an orderly assembly structure (rather than in a random assembly structure). The orderly assembly structure can be measured using X-ray powder diffraction analysis such as by one or more peaks at a diffraction angle that corresponds to a d-value (or d-spacing) of at least 1 nm in an X-ray pattern. An ordered structure diffracts X rays in a manner that certain diffracted rays may be “additive” when reaching a detector (or allocation on an array detector or film), while other rays will not be additive. (See, e.g., Bragg equation; http://www.esere.stonybrook.edu/projectjava/bragg/). Briefly, two diffracted rays will arrive at the detector location in an additive manner if: nl=2 d sin θ, wherein n is an integer, l is the wavelength of the X ray, θ is the angle and d is the inter-atomic spacing. Only when a substance with an ordered structure will the diffraction produce enough additive diffractive beams to produce a peak with the magnitude of the peak indicative of the level of orderness of the substance. Thus, the presence or absence and the intensity of the peak are indicative of the “orderness” of the substance.

### DETAILED DESCRIPTION OF THE INVENTION

The invention provides superficially porous monoliths with ordered pore structures. The superficially porous monoliths comprise a skeleton and an outer shell. Both the skeleton and the outer shell are either metal oxide or hybrid metal oxide material. The metal oxide can be silica, alumina, titania and zirconia. The hybrid metal oxide contains metal oxide that is organically modified via covalent bonding. The superficially porous monoliths of the invention provide several major advantages over existing silica monoliths. When used in chromatography, the superficially porous hybrid silica monoliths of the invention deliver fast separation at very low back pressure and possess superb pH stability and much improved mechanical strength.

First, compared to monoliths with totally porous monolith skeleton, superficially porous monoliths are characterized by shortened diffusion length due to the thin porous outer shell/layer and provide fast diffusion rates. (See, e.g., Kirkland, 1970, U.S. Pat. No. 3,505,785; Felinger 2011 J. of Chroma. A, 1218, 1939.) The densified skeleton core also provides improved mechanical strength.

Secondly, porous silica substrates may be backfilled with a variety of functionalized silanes (U.S. Pat. No. 8,277,883 to Chen, et al.). Superficially porous monoliths can be backfilled with organofunctional silanes to produce hybrid monolith structures.

Another unique feature of the superficially porous monoliths of the invention is the transformation of the solid skeleton to have a superficially porous outer layer with ordered mesopore structure. The ordered pore structure with well-aligned channels and narrow pore size distribution is particularly suited for providing uniform mass transport pathways. The pores are generally normal to the surface and thus further facilitate the diffusion of analytes to the adsorptive sites. (See, e.g., Wei, et al., 2010, U.S. Patent Pub. No. 2010/0051877 A1.)

Yet another unique feature is that the use of hybrid metal oxide such as hybrid silica. For example, when bridged silsesquioxane is incorporated into the silica skeleton, the monolith demonstrates similar retention factors with much higher pH stability. (Nakanishi, et al. 2004 Chem. Mater. 16, 3652.)

The pseudomorphic transformation process can be applied to monoliths comprising any solid metal oxides/hybrids, such as silica, alumina, titania, and zirconia, to make superficially porous silica, alumina, titania, and zirconia monoliths, or hybrids thereof. “Pseudomorphism” is a term used by mineralogists to describe phase transformation that does not change the shape of a material. Thus the pseudomorphic synthesis disclosed herein, for examples assisted by a surfactant, for pre-shaped solid silica monoliths forms a porous outer layer with highly ordered narrow mesopore size distribution, high surface area and pore volume without changing the initial shape. The high specific surface area, high pore volume, and adjustable pore size together improve the retention capacity and molecular selectivity as well as provide an overall improvement in mass transfer between the stationary and mobile phase.

In one aspect, the invention generally relates to a porous monolith, which includes: (1) an organically modified porous skeleton comprising continuous macropores; and (2) a substantially porous outer shell comprising substantially ordered mesopores. Each of the skeleton and the outer shell is independently metal oxide or hybrid metal oxide. The metal oxide is selected from silica, alumina, titania and zirconia. In certain preferred embodiments, the metal oxide is silica and the hybrid metal oxide comprises bridged polysilsesquioxane, such as 1,2-bis(triethoxysilyl)ethane and 1,2-bis(triethoxysilyl)benzene.

In certain preferred embodiments, the hybrid metal oxide can be introduced during the synthesis of monolith, organosilane backfill or pseudomorphic transformation.

The continuous macropores may have any suitable pore size. In certain embodiments, the continuous macropores have a median pore size ranges from about 0.2 μm to about 10 μm (e.g., from about 0.5 μm to about 10 μm, from about 1 μm to about 10 μm, from about 2 μm to about 10 μm, from about 3 μm to about 10 μm, from about 4 μm to about 10 μm, from about 5 μm to about 10 μm, from about 0.2 μm to about 8 μm, from about 0.2 μm to about 6 μm, from about 0.2 μm to about 5 μm, from about 0.2 μm to about 4 μm, from about 0.2 μm to about 3 μm, from about 0.2 μm to about 2 μm, from about 0.2 μm to about 1 μm, from about 0.5 μm to about 5 μm, from about 1 μm to about 5 μm) with a pore size distribution (one standard deviation) of no more than 50% of the median pore size.

The substantially ordered mesopores may have any suitable pore size. In certain embodiments, the substantially ordered mesopores have a median pore size ranges from about 1 nm to about 100 nm (e.g., from about 2 nm to about 100 nm, from about 5 nm to about 100 nm, from about 10 nm to about 100 nm, from about 20 nm to about 100 nm, from about 30 nm to about 100 nm, from about 40 nm to about 100 nm, from about 50 nm to about 100 nm, from about 1 nm to about 50 nm, from about 1 nm to about 40 nm, from about 1 nm to about 30 nm, from about 1 nm to about 20 nm, from about 1 nm to about 10 nm, from about 1 nm to about 5 nm, from about 2 nm to about 50 nm, from about 10 nm to about 50 nm) with a pore size distribution (one standard deviation) of no more than 50% of the median pore size.

In certain embodiments, the organically modified porous skeleton is modified by silsesquioxane. The silsesquioxane comprises bridged polysilsesquioxane.

The porous monolith may have any suitable median surface area. In certain embodiments, the porous monolith has a median surface area in the range from about 5 m²/g to about 1,000 m²/g (e.g., from about 10 m²/g to about 1,000 m²/g, from about 50 m²/g to about 1,000 m²/g, from about 100 m²/g to about 1,000 m²/g, from about 200 m²/g to about 1,000 m²/g, from about 500 m²/g to about 1,000 m²/g, from about 5 m²/g to about 500 m²/g, from about 5 m²/g to about 200 m²/g, from about 5 m²/g to about 100 m²/g, from about 5 m²/g to about 50 m²/g, from about 10 m²/g to about 500 m²/g, from about 10 m²/g to about 300 m²/g, from about 10 m²/g to about 200 m²/g, from about 100 m²/g to about 500 m²/g).

In certain embodiments, the substantially ordered mesopores may form aligned channels having a median length ranging from about 0.01 μm to about 5 μm (e.g., from about 0.01 μm to about 3 μm, from about 0.01 μm to about 2 μm, from about 0.01 μm to about 1 μm, from about 0.01 μm to about 0.5 μm, from about 0.01 μm to about 0.1 μm, from about 0.02 μm to about 5 μm, from about 0.05 μm to about 5 μm, from about 0.1 μm to about 5 μm, from about 0.2 μm to about 5 μm, from about 0.5 μm to about 5 μm, from about 1 μm to about 5 μm, from about 0.03 μm to about 3 μm, from about 0.05 μm to about 3 μm, from about 0.1 μm to about 3 μm, from about 0.3 μm to about 3 μm) and a length distribution (one standard deviation) of no more than 50% (e.g., no more than 40%, no more than 30%) of the median channel length.

The thickness of the substantially porous outer shell may have any suitable thickness, which can be adjusted, for example, by varying the reaction conditions such as the pH and reaction time. The thickness of the substantially porous outer shell may be from about 1% to about 99% (e.g., from about 1% to about 90%, from about 1% to about 80%, from about 1% to about 70%, from about 1% to about 60%, from about 1% to about 50%, from about 1% to about 40%, from about 1% to about 30%, from about 1% to about 20%, from about 1% to about 10%, from about 1% to about 5%, from about 1% to about 3%, from about 3% to about 80%, from about 3% to about 70%, from about 3% to about 50%, from about 3% to about 30%, from about 3% to about 20%) of the skeleton diameter of the skeleton.

The organically modified porous skeleton may comprise from about 1% w/w to about 100% w/w (e.g., from about 1% w/w to about 100% w/w, from about 2% w/w to about 100% w/w, from about 5% w/w to about 100% w/w, from about 10% w/w to about 100% w/w, from about 20% w/w to about 100% w/w, from about 30% w/w to about 100% w/w, from about 50% w/w to about 100% w/w, from about 60% w/w to about 100% w/w, from about 80% w/w to about 100% w/w, from about 1% w/w to about 90% w/w, from about 1% w/w to about 70% w/w, from about 1% w/w to about 50% w/w, from about 5% w/w to about 90% w/w, from about 1% w/w to about 80% w/w, from about 1% w/w to about 60% w/w, from about 10% w/w to about 90% w/w, from about 10% w/w to about 80% w/w, from about 10% w/w to about 60% w/w, from about 10% w/w to about 40% w/w, from about 40% w/w to about 90% w/w) of bridged polysilsesquioxane.

In another aspect, the invention generally relates to a method for preparing substantially metal oxide or hybrid metal oxide monoliths. The method includes: providing macroporous monoliths with solid skeleton by sintering, tetraethyl orthosilicate or (TEOS)/organosilane backfill; and heating the macroporous monoliths in a basic aqueous environment in the presence of one or mixed surfactants at a pH and for a time sufficient to create porous outer shells thereon having substantially ordered mesopores. The method may further include modifying the surface of the macroporous silica monolith with a surface modifier.

It is well known that metal oxides of silica, alumina, zirconia and titania can be dissolved in either strong basic or acidic solution, depending on the metal oxide. For example, silica can be dissolved in a high pH solution such as sodium hydroxide or ammonia solution, and in a hydrofluoric acid solution. In the process of the present invention, metal oxide monoliths are only partially dissolved. As such, the pH range can be broader for partial dissolution as compared to complete dissolution. For example, in the case of alumina solid monoliths, acidic pH can be used for dissolution of alumina (and negatively charged surfactants or non-ionic surfactants can be used to form pores). Where the solid monoliths comprise silica, the solution can contain fluoride ion such as hydrofluoric acid or ammonium fluoride for partial dissolution. For example, silica can be partially dissolved in the presence of hydrofluoric acid at a concentration from 50 ppm to 5000 ppm. When such an acid is used, the concentration of hydrofluoric acid is preferably 200 to 800 ppm. Alternatively, the solid silica monoliths can be partially dissolved where the pH of the solution is basic from about 10 to about 13.5, more preferably from about 12 to about 13.5. The base used to achieve such basic pH is preferably one such as ammonium hydroxide.

In preferred embodiments of the methods disclosed herein, a surfactant is used. The surfactant may be any suitable surfactant. For example, one or more ionic surfactants or non-ionic surfactants may be sued. Preferably, the surfactant is selected from one or more of the group of polyoxyethylene sorbitans, polyoxythylene ethers, block copolymers, alkyltrimethylammonium, alkyl phosphates, alkyl sulfates, alkyl sulfonates, sulfosuccinates, carboxylic acid, surfactants comprising an octylphenol polymerized with ethylene oxide, and combinations thereof. Most preferably the surfactant(s) is selected from one or more of a compound of the formula CₙH₂ₙ₊₁(CH₃)₃NX, wherein X is selected from chlorine and bromine, and n is an integer from 10 to 20. Examples of preferred surfactants include trimethyloctadecylammonium bromide and hexadecyltrimethylammonium bromide. In certain embodiments, the surfactant is a cationic surfactant, for example, comprising a trimethylammonium ion. In certain embodiments, the surfactant is a cationic surfactant selected from hexadecyltrimethylammonium bromide (C16TAB) and octadecyltrimethylammonium bromide (C18TAB).

Regarding the temperatures for the process of this invention, the solution is typically either under reflux or in an autoclave at a temperature higher than about 50° C. from one hour to days, preferably under reflux. The term “under reflux” here refers to the technique where the solution, optionally under stirring, inside a reaction vessel is connected to a condenser, such that vapors given off by the reaction mixture are cooled back to liquid, and sent back to the reaction vessel. The vessel can then be heated at the necessary temperature for the course of the reaction. The purpose is to accelerate the reaction thermally by conducting it at an elevated temperature (i.e., the boiling point of the aqueous solution). The advantage of this technique is that it can be left for a long period of time without the need to add more solvent or fear of the reaction vessel boiling dry as the vapor is condensed in the condenser. In addition, as a given solvent will always boil at a certain temperature, one can be sure that the reaction will proceed at a fairly constant temperature within a narrow range. In certain embodiments, the heating the macroporous silica monolith is performed in an aqueous environment at a temperature between about 70° C. to about 160° C. (e.g., at about 70° C., at about 80° C., at about 90° C., at about 100° C., at about 110° C., at about 120° C., at about 130° C., at about 140° C., at about 150° C., at about 160° C.) and a pH from about 10 to about 13 (e.g., at about 10, at about 10.5, at about 11, at about 11.5, at about 12, at about 12.5, at about 13), for example, in the presence of hexadecyltrimethylammonium bromide, and for a time from about 1 to about 10 days (e.g., for about 1 day, for about 2 days, for about 3 days, for about 4 days, for about 5 days, for about 6 days, for about 7 days, for about 8 days, for about 9 days).

The process may preferably employ a swelling agent that can dissolve into the surfactant micelles. The swelling agent causes the micelles to swell, increasing (adjusting) the size of the pores to the desired size. Preferably, the mixture of the pH adjuster (the base or acid), solid silica (or other metal oxide) particles and surfactant is heated for a time (e.g., 20 min. to 1.5 hrs) at a temperature of from 30° C. to 60° C. before the swelling agent is added. Exemplary swelling agents include alkyl substituted benzene, dialkylamine, trialkylamine, tertraalkyl ammonium salt, alkane of the formula (CHₙH₂ₙ₋₂) where n is an integer of 5-20, cycloalkane of the formula (CₙH₂ₙ) where n is an integer of 5-20, substituted alkane of the formula (X—CH₂ₙ₊₁) where n is an integer of 5-20 and X is chloro, bromo, or —OH, or a substituted cycloalkane of the formula (X—CₙH₂ₙ₋₁) where n is an integer of 5-20 and X is chloro-, bromo-, or —OH. Preferred swelling agents include trimethylbenzene (Beck, U.S. Pat. No. 5,057,296); triisopropylbenzene (Kimura, et al. 1998 J. Chem. Soc., Chem. Commun. 1998, 559); N,N-dimethylhexadecylamine, N,N-dimethyldecylamine, trioctylamine and tridodecylamine (Sayari, et al. 1998 Adv. Mater. 10, 1376); cyclohexane, cyclohexanol, dodecanol, chlorododecane and tetramethylammonium and tetraethylammonium sodium salts (Corma, et al. 1997 Chem. Mater. 9, 2123).

The solid monoliths, the surfactant and the optional swelling agent may be subjected to elevated temperature in the aqueous solution, preferably under reflux. The micelles formed in the solution cause the metal oxide dissolved from the partially dissolved metal oxide monoliths to re-deposit onto the partially dissolved particles due to the attraction of the dissolved metal oxide to the micelles. After the treatment, for example reflux, is complete, the monoliths are separated from the solution (e.g., by centrifugation, filtration and the like), and the monoliths are subjected to a treatment (e.g., with elevated temperature) to drive off (e.g., combust or volatilize) the surfactant and swelling agent from the particles. If the optional organosilane is bound (e.g., covalently) to the particles, the particles are subjected to a solvent extraction treatment (e.g., agitating in ethanol/HCl with elevated temperature) to wash off the surfactant and swelling agent from the particles so that the organosilane still remains bound after such treatment.

In yet another aspect, the invention generally relates to a superficially porous monolith, The monolith includes: (1) a porous skeleton comprising continuous macropores with a median pore size ranging from about 0.5 μm to 10 μm; (2) a substantially porous outer shell comprising mesopores with a median pore size ranges from about 1 nm to about 100 nm with a pore size distribution (one standard deviation) of no more than 50% of the median pore size; and wherein the skeleton is a hybrid silica skeleton comprising silica and bridged silsesquioxane. The superficially porous monoliths have a median surface area in the range from about 100 m²/g to about 1,000 m²/g. In certain preferred embodiments, the mesopores in the substantially porous outer shells are substantially ordered.

In certain embodiments, the surface modifier has the formula

Zₐ(R′)_{b}Si—R,

where
Z=Cl, Br, I, C₁-C₅ alkoxy, dialkylamino, trifluoroacetoxy or trifluoromethanesulfonate;
a and b are each an integer from 0 to 3 provided that a+b=3;
R′ is a C₁-C₆ straight, cyclic or branched alkyl group, and
R is selected from alkyl, alkenyl, alkynyl, aryl, diol, amino-, alcohol, amide, cyano, ether, nitro, carbonyl, epoxide, sulfonyl, cation exchanger, anion exchanger, carbamate and urea.

In certain embodiments, R is a C₁-C₃₀ alkyl group. In certain embodiments, the surface modifier is selected from octyltrichlorosilane, octadeyltrichlorosilane, octyldimethylchlorosilane, and octadecyldimethylchlorosilane.

The superficially porous monoliths of the invention can be applied in various applications in catalysis, adsorption, sensing and separations. In certain embodiments, the superficially porous monoliths are used in chromatography, for example, in HPLC.

### EXAMPLES

### Example 1

### Synthesis of Macroporous Monolith with Solid Skeleton by Sintering or TEOS Backfill

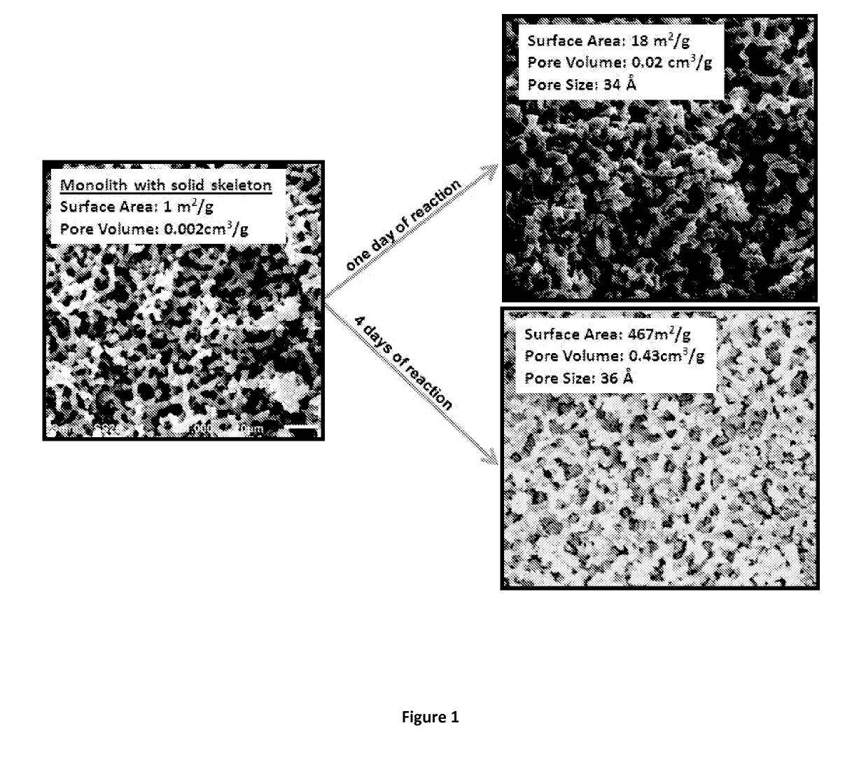

Acetic Acid (200 g of 0.01M) was add into 25 mL plastic bottle and placed in an ice bath with stirring. Polyethylene glycol (PEG) (16.8 g) was added into the mixture and stirred for 10 min. for full dissolving. Tetramethoxysilane (TMOS) (104 mL) was added into the mixture and stirred for additional 30 min. in an ice bath. The hydrolyzed liquid was transferred into Pynex glass tubes (6 mm×50 mm). All tubings were put into a plastic box container with sealing cover. The box container was immersed into a 40° C. VWR water bath, and waited for gelling and then set for aging overnight. The synthesized monolith rods were dried in glass tubings at 60° C. for 14 hrs and then the temperature was increased to 120° C. at a ramp rate of 1° C./min. and kept at 120° C. for 2 hrs. The temperature was further raised to 600° C. at 2° C./min. and kept at 600° C. for 2 hrs. The measured surface area is 377 m²/g. SEM images confirmed the formation of a monolith structure in FIG. 1.

Sample 1A: Some of the rods were further heated to 900° C. for 2 hrs. The surface area dropped from 377 m²/g to 0.45 m²/g demonstrating the formation of solid skeleton.

Sample 1B: Some of the rods were further refluxed in 400 ppm HF solution and 20 wt % (of silica monolith) of TEOS for 20 hours. Then allowed to cool down to room temperature, rinsed with DI water, EtOH in sequence, then dried in furnace starting at 120° C. overnight. The surface area dropped from 377 m²/g to 0.26 m²/g demonstrating the formation of solid skeleton.

### Example 2

### Transformation of Solid Skeleton into Superficially Porous Structure with Different Reaction Time

Sample A: DI water and C16TAB was premixed at a ratio of 50 g:0.39 g and the mixture was stirred in hot water bath for 30 min. 1.6 g of tridecane was added in the solution and was stirred for another 30 min. 13.0 g of ammonium hydroxide was added into the mixture, add solid silica monolith rods (made from Sample 1A of Example 1) into an autoclave oven at 100° C. for one day. The monolith rods were rinsed with DI water, EtOH and Acetone, which were burned off again from 120° C. to 600° C. at a ramp rate of 2° C./min. followed by keeping the temperature at 600° C. for 2 hrs. The surface area was found to have increased from 0.45 m²/g to 18 m²/g with a BET pore size of 34 Å.

Sample B: DI water and C16TAB was premixed at a ratio of 50 g:0.39 g and the mixture was stirred in hot water bath for 30 min. 1.6 g of tridecane was added in the solution and was stirred for another 30 min. 13.0 g of ammonium hydroxide was added into the mixture, add solid silica monolith rods (made from Sample 1A of Example 1) into an autoclave oven at 100° C. for four days. The monolith rods were rinsed with DI water, EtOH and Acetone, which were burned off again from 120° C. to 600° C. at a ramp rate of 2° C./min. followed by keeping the temperature at 600° C. for 2 hrs. The surface area was found to have increased from 0.45 m²/g to 467 m²/g with a BET pore size of 36 Å. The SEM image confirmed the monolith structure was maintained in FIG. 1. The greatly increased surface area demonstrates the formation of porous outer layer after 4 days of reaction.

TABLE 1
Formation of a porous skeleton from a non-porous monolith skeleton

| | | Reaction | | |
|---|---|---|---|---|
| | | time | SA | PS |
| Sample | Method | (days) | (m²/g) | (Å) |
| 1A | Silica monolith + Sintering | | 0.45 | 48 |
| 2A | Silica monolith + Sintering + | 1 | 18 | 34 |
| | C16TAB | | | |
| 2B | Silica monolith + Sintering + | 4 | 467 | 36 |
| | C16TAB | | | |

### Example 3

### Transformation of Solid Skeleton into Superficially Porous Structure with Large Pores

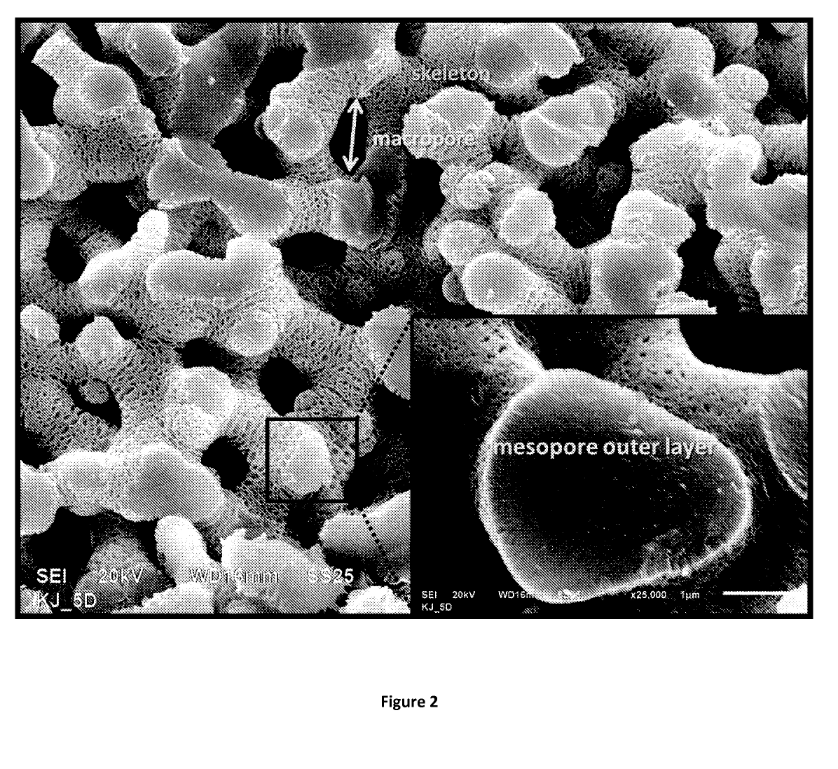

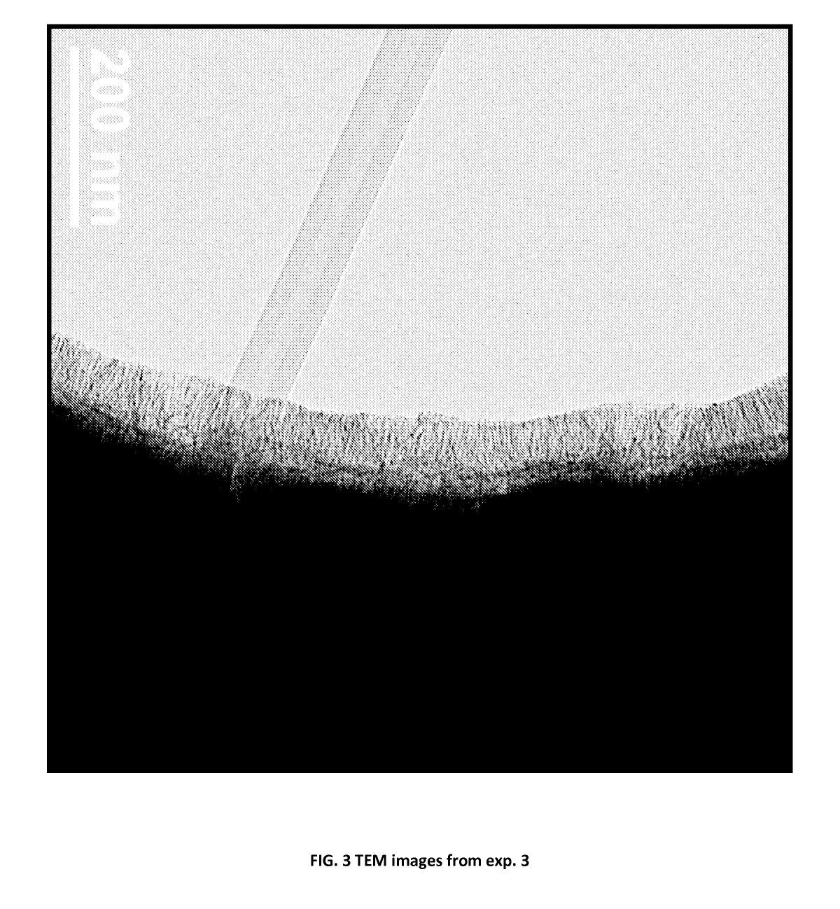

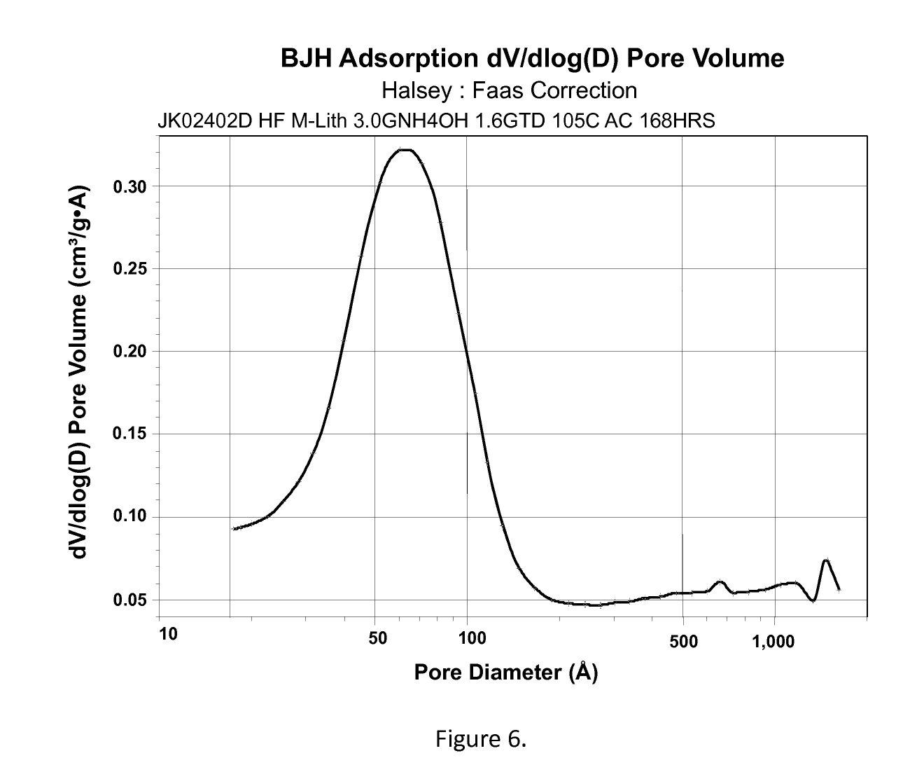

DI water and C18TAB was premixed at a ratio of 50 g:0.39 g and the mixture was stirred in hot water bath for 30 min. 1.6 g of tridecane was added in the solution and was stirred for another 30 min. 3.0 g of ammonium hydroxide was added into the mixture, add solid silica monolith rods (made from Sample 1B of Example 1) into an autoclave oven at 105° C. for 5 days. The monolith rods were rinsed with DI water, EtOH and Acetone, which were burned off again from 120° C. to 600° C. at a ramp rate of 2° C./min. followed by keeping the temperature at 600° C. for 2 hrs. The surface area was found to have increased from 0.26 m²/g to 171 m²/g with a BET pore size of 60 Å. SEM and TEM images are shown in FIG. 2 and FIG. 3, respectively. FIG. 6 shows exemplary N₂ sorption data. The increased pore size indicates the effect of adding swelling agent. Also the TEM image demonstrates the presence of ordered pore structure on the outer layer.

### Example 4

### Transformation of Solid Skeleton into Superficially Porous Structure with Large Pores

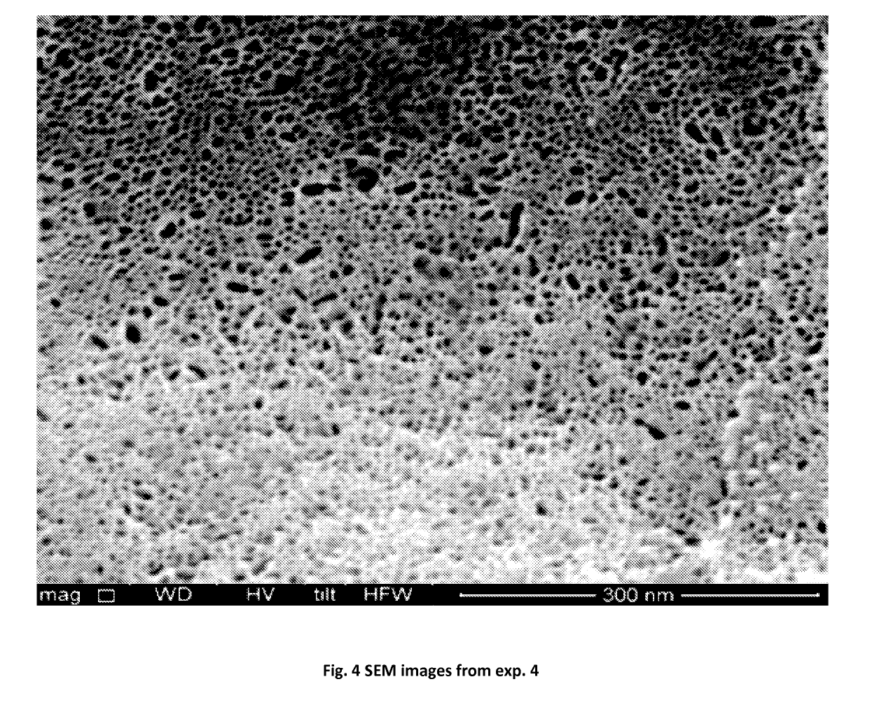

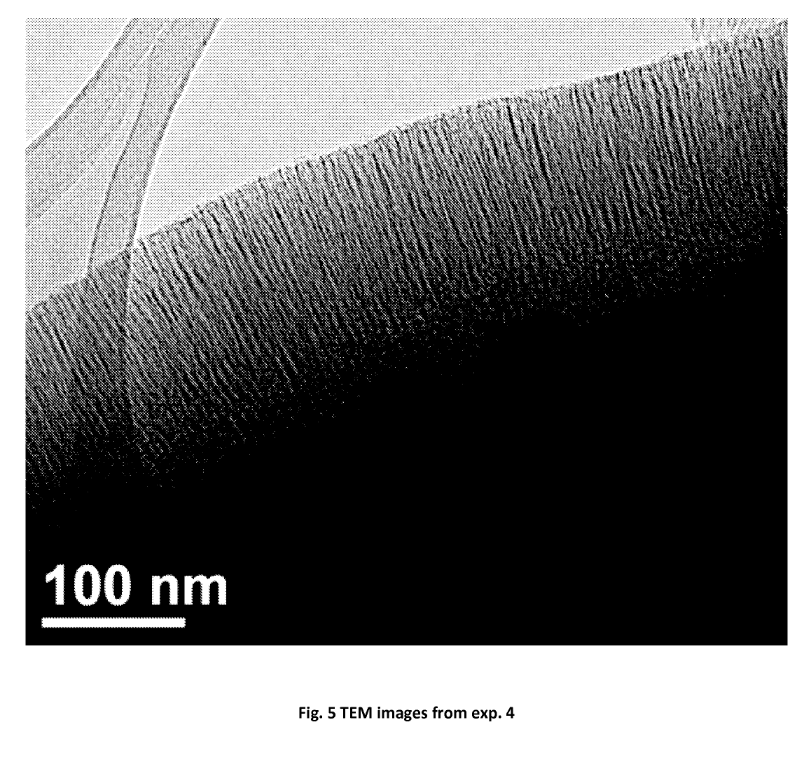

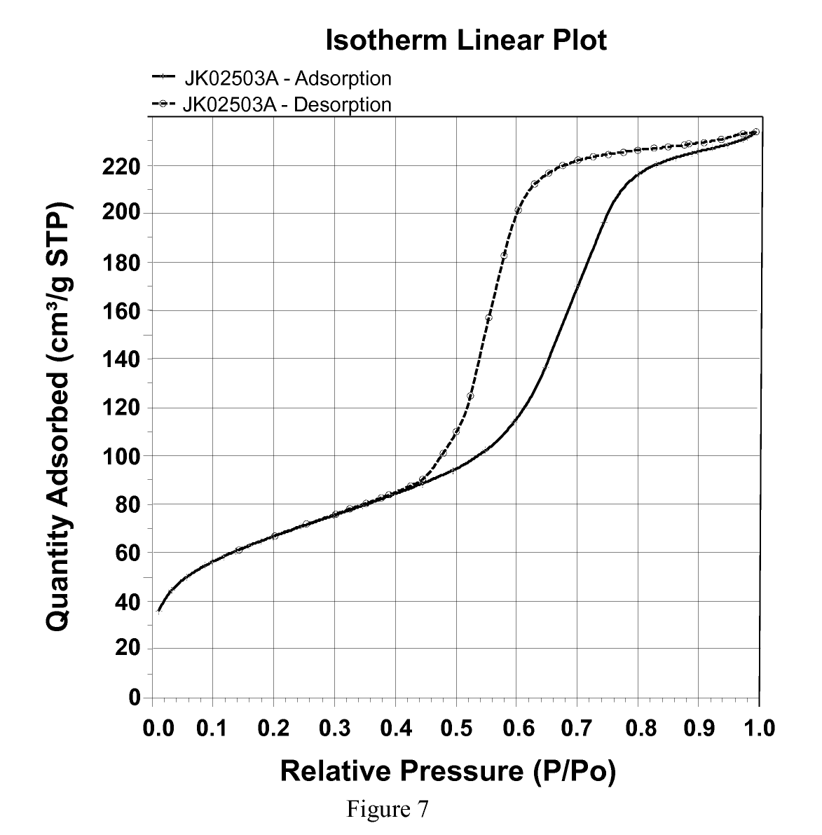

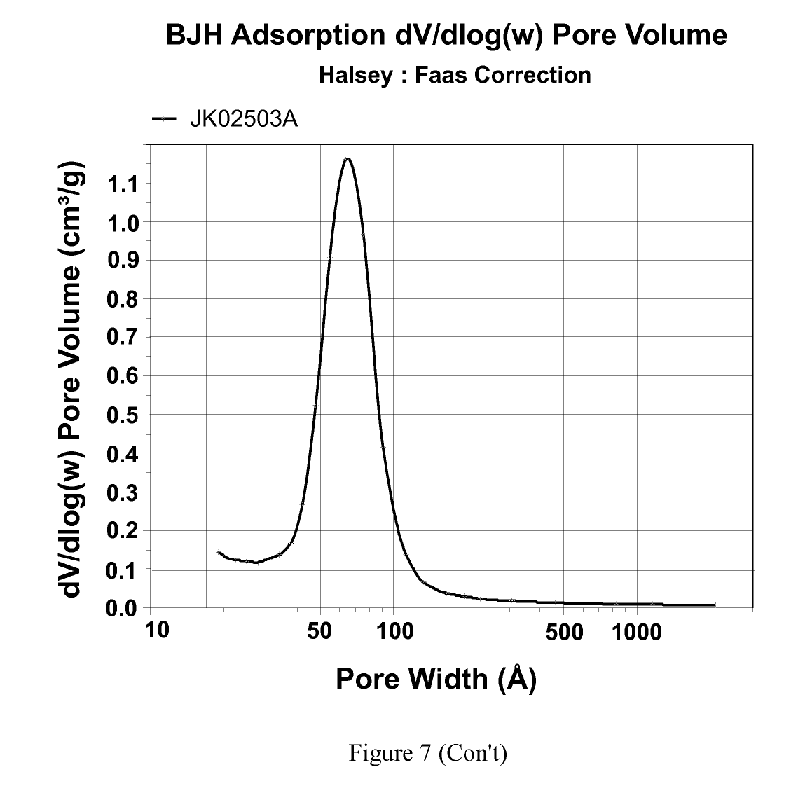

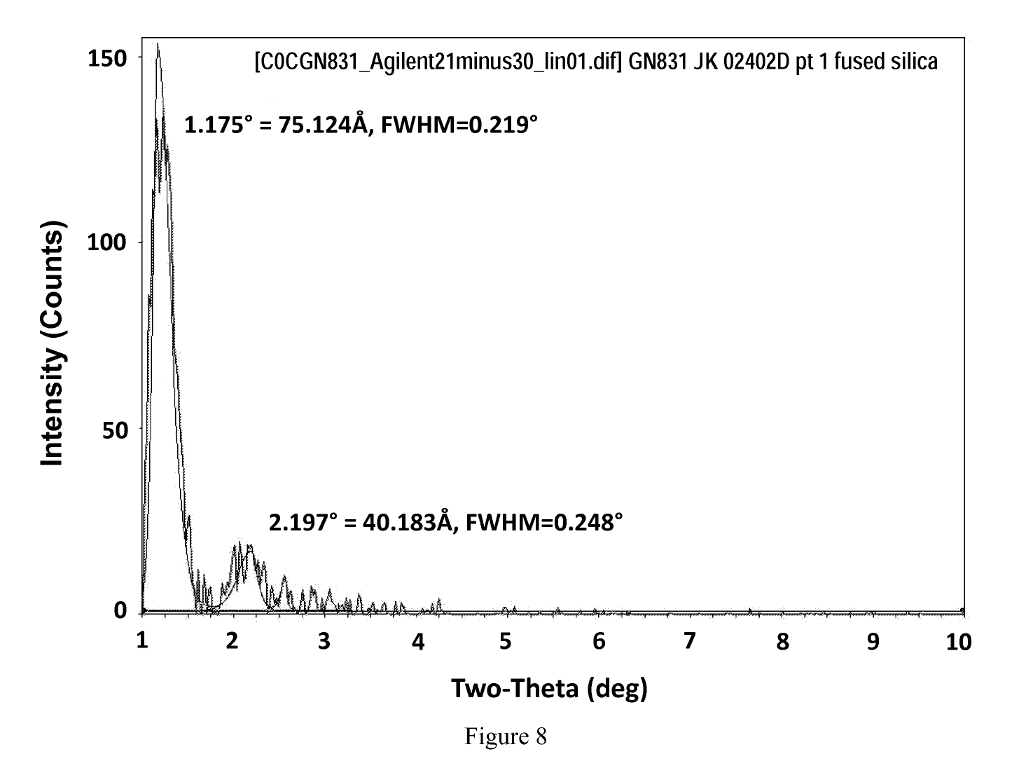

DI water and C18TAB was premixed at a ratio of 50 g:0.39 g and the mixture was stirred in hot water bath for 30 min. 1.6 g of dodecane was added in the solution and was stirred for another 30 min. A base 3.0 g of ammonium hydroxide was added into the mixture, add silica monolith rods (made from Sample 1B of Example 1) into an autoclave oven at 105° C. for 3 days. The monolith rods were rinsed with DI water, EtOH and Acetone, which were burned off again from 120° C. to 600° C. at a ramp rate of 2° C./min. followed by keeping the temperature at 600° C. for 2 hrs. The surface area was found to have increased from 0.26 m²/g to 230 m²/g with a BET pore size of 63 Å. SEM and TEM images are shown in FIG. 4 and FIG. 5, respectively. FIG. 7 shows exemplary N₂ sorption data. XRD data is shown in FIG. 8. The increased pore size indicates the effect of adding swelling agent. Also the TEM image and XRD data demonstrate the presence of ordered pore structure on the outer layer.

TABLE 2
Ordered pore silica monolith generated by using CTAB
as surfactant and a swelling agent

| | | Swelling | SA | PS |
|---|---|---|---|---|
| Sample | Method | agent | (m²/g) | (Å) |
| 1B | Silica monolith + TEOS backfill | | 0.26 | — |
| 3 | Silica monolith + TEOS backfill + | tridecane | 171 | 60 |
| | C18TAB | | | |
| 4 | Silica monolith + TEOS backfill + | dodecane | 230 | 63 |
| | C18TAB | | | |

### Example 5

### Synthesis of Superficially Porous Hybrid Monolith with Ordered Pore Structure

Sample A: Some of the silica monolith rods prepared in example 1 were further refluxed in 400 ppm HF solution with 20 wt % (of monolith) of BES (1,2-Bis(triethoxysilyl)ethane) for 20 hours. Then allowed to cool down to room temperature, rinsed with DI water, EtOH in sequence, then dried in furnace starting at 120° C. overnight.

Sample B: Macroporous monolith with hybrid skeleton can be synthesized directly from sol-gel process starting with TEOS and BES (1,2-Bis(triethoxysilyl)ethane) at 4:1 mass ratio. (Nakanishi, et al. 2004 Chemistry of Materials 16 (19), 3652-3658.)

Sample C: Hybrid monolith rods from Sample B (1.0 g) were further refluxed in 400 ppm HF solution with 20 wt % of (of monolith) of TEOS for 20 hours. Then allowed to cool down to room temperature, rinsed with DI water, EtOH in sequence, then dried in furnace starting at 120° C. overnight.

Sample D: Hybrid monolith rods from Sample B (1.0 g) were further refluxed in 400 ppm HF solution with 20 wt % (of monolith) of of BES for 20 hours. Then allowed to cool down to room temperature, rinsed with DI water, EtOH in sequence, then dried in furnace starting at 120° C. overnight.

Sample A, C and D were then transformed to generate superficially porous layer by the same process: DI water and C18TAB was premixed at a ratio of 50 g:0.39 g and the mixture was stirred in hot water bath for 30 min. 1.6 g of tridecane was added in the solution and was stirred for another 30 min. 3.0 g of ammonium hydroxide was added into the mixture, add solid monolith rods into an autoclave oven at 105° C. for 3 days. The monolith rods were rinsed with DI water, EtOH and Acetone, which were burned off again from 120° C. to 350° C. at a ramp rate of 1° C./min. followed by keeping the temperature at 350° C. for 2 hrs. The surface area, pore size and carbon percentage for sample 5A, 5C and 5D are listed in Table 3 below. The C % increases up to 3.68% demonstrates the formation of superficially porous hybrid monolith.

TABLE 3
Surface Area (SA), Pore Size (PS) and Carbon (C) Percentage

| | | SA | PS | C % |
|---|---|---|---|---|
| Sample | Method | (m²/g) | (Å) | (%) |
| 3 | Silica monolith + 20% TEOS + | 171 | 60 | 0.01 |
| | C18CTAB | | | |
| 5A | Silica monolith + 20% BES + C18CTAB | 405 | 54 | 2.38 |
| 5C | Hybrid monolith + 20% TEOS + | 369 | 52 | 2.80 |
| | C18CTAB | | | |
| 5D | Hybrid monolith + 20% BES + C18CTAB | 470 | 70 | 3.68 |

In this specification and the appended claims, the singular forms “a,” “an,” and “the” include plural reference, unless the context clearly dictates otherwise.

Unless defined otherwise, all technical and scientific terms used herein have the same meaning as commonly understood by one of ordinary skill in the art. Although any methods and materials similar or equivalent to those described herein can also be used in the practice or testing of the present disclosure, the preferred methods and materials are now described. Methods recited herein may be carried out in any order that is logically possible, in addition to a particular order disclosed.

### INCORPORATION BY REFERENCE

References and citations to other documents, such as patents, patent applications, patent publications, journals, books, papers, web contents, have been made in this disclosure. All such documents are hereby incorporated herein by reference in their entirety for all purposes. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

### EQUIVALENTS

The representative examples disclosed herein are intended to help illustrate the invention, and are not intended to, nor should they be construed to, limit the scope of the invention. Indeed, various modifications of the invention and many further embodiments thereof, in addition to those shown and described herein, will become apparent to those skilled in the art from the full contents of this document, including the examples and the references to the scientific and patent literature cited herein. While the invention has been described with respect to a limited number of embodiments, the scope of the invention should be limited only by the attached claims.

What is claimed is:

1. A porous monolith, comprising:
an organically modified solid skeleton comprising continuous macropores; and
a substantially porous outer shell comprising substantially ordered mesopores, wherein both the skeleton and the outer shell are independently metal oxide or hybrid metal oxide; and wherein the metal oxide is selected from silica, alumina, titania and zirconia.

2. The porous monolith of claim 1, wherein the metal oxide is silica.

3. The porous monolith of claim 2, wherein the continuous macropores have a median pore size ranges from about 0.2 μm to about 10 μm.

4. The porous monolith of claim 2, wherein the substantially ordered mesopores have a median pore size ranges from about 1 nm to about 100 nm with a pore size distribution (one standard deviation) of no more than 50% of the median pore size.

5. The porous monolith of claim 4, wherein the substantially ordered mesopores have a median pore size ranges from about 2 nm to about 50 nm with a pore size distribution (one standard deviation) of no more than 50% of the median pore size.

6. The porous monolith of claim 2, wherein the hybrid silica skeletons are modified by silsesquioxane.

7. The porous monolith of claim 6, wherein silsesquioxane comprises bridged polysilsesquioxane.

8. The porous monolith of claim 2, wherein the silica monoliths have a median surface area in the range from about 5 m²/g to about 1,000 m²/g.

9. The porous monolith of claim 8, wherein the silica monoliths have a median surface area in the range from about 100 m²/g to about 500 m²/g.

10. The porous monolith of claim 7, wherein the mesopores are substantially ordered forming aligned channels having a median length ranging from about 0.01 μm to about 5 μm and a length distribution (one standard deviation) of no more than 30% of the median channel length.

11. The porous monolith of claim 1, wherein the thickness of the outer shell is from about 1% to about 99% of the skeleton diameter of the skeleton.

12. The porous monolith of claim 7, wherein the hybrid silica skeletons comprise from about 1% w/w to about 100% w/w of bridged polysilsesquioxane.

13. A method for preparing substantially metal oxide or hybrid metal oxide monoliths, comprising:
providing macroporous monoliths with solid skeleton; and
heating the macroporous monoliths in a basic aqueous environment in the presence of one or mixed surfactants at a pH and for a time sufficient to create porous outer shells thereon having substantially ordered mesopores.

14. The method of claim 13, wherein the surfactant is selected from hexadecyltrimethylammonium bromide (C16TAB) and octadecyltrimethylammonium bromide (C18TAB).

15. The method of claim 13, wherein heating the macroporous silica monoliths is performed in an aqueous environment in the presence of hexadecyltrimethylammonium bromide at a temperature between about 70° C. to about 160° C., at a pH from about 10 to about 13, and for a time from about 1 to about 10 days.

16. The method of claim 13, wherein the substantially ordered mesopores have a median pore size ranges from about 1 nm to about 100 nm with a pore size distribution (one standard deviation) of no more than 50% of the median pore size.

17. The method of claim 13, further comprising modifying the surface of the monoliths with a surface modifier having the formula
Zₐ(R′)_{b}Si—R,
where
Z=Cl, Br, I, C₁-C₅ alkoxy, dialkylamino, trifluoroacetoxy or trifluoromethanesulfonate;
a and b are each an integer from 0 to 3 provided that a+b=3;
R′ is a C₁-C₆ straight, cyclic or branched alkyl group, and
R is selected from alkyl, alkenyl, alkynyl, aryl, diol, amino-, alcohol, amide, cyano, ether, nitro, carbonyl, epoxide, sulfonyl, cation exchanger, anion exchanger, carbamate and urea groups.

18. The method of claim 17, wherein the surface modifier is selected from octyltrichlorosilane, octadeyltrichlorosilane, octyldimethylchlorosilane, and octadecyldimethylchlorosilane.

19. The method of claim 17, wherein R is selected from alkyl, alkenyl, alkynyl, aryl, diol, amino, alcohol, amide, cyano, ether, nitro, carbonyl, epoxide, sulfonyl, carbamate and urea groups.

20. The method of claim 17, wherein R is a C₁-C₃₀ alkyl group.
